(19) United States
(12) Patent Application Publication
(10) Pub. No.: US 2004/0203972 A1
(43) Pub. Date: Oct. 14, 2004

(54) Method of snmp printing device/user communication for detecting imaging device proximity

(76) Inventors: Robert D. Christiansen, Boise, ID (US); Patrick O. Sandfort, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/104,922

(22) Filed: Mar. 21, 2002

(51) Int. Cl. H04B 7/00

(52) U.S. Cl. 455/517; 455/456.1

(57) ABSTRACT

This invention relates to a method for determining a unique identifier of an imaging device. Such structures of this type, generally, detect the closest imaging device to the user by having the user's mobile device query the online/off-line status of all the imaging devices in the current network list. The user then presses a key on the imaging device. The user's mobile device then polls all the imaging devices in the list to see which imaging devices have made online/off-line transition. A message is posted on the control panel of the imaging device as a means of providing confirmation to the user that this is the imaging device the user desires to print from. Finally, the imaging device returns a unique identifier, such as a network address, to the user's mobile device so that the user can download the print job information from the mobile device to the imaging device and the document can be printed.

### FIELD OF THE INVENTION

This invention relates to a method for determining a unique identifier of an imaging device. Such structures of this type, generally, detect the closest imaging device to the user by having the user's mobile device query the online/off-line status of all the imaging devices in the current network list. The user then presses a key on the imaging device. The user's mobile device then polls all the imaging devices in the list to see which imaging devices have made online/off-line transition. A message is posted on the control panel of the imaging device as a means of providing confirmation to the user that this is the imaging device the user desires to print from. Finally, the imaging device returns a unique identifier, such as a network address, to the user's mobile device so that the user can download the print job information from the mobile device to the imaging device and the document can be printed.

### DESCRIPTION OF THE RELATED ART

Prior to the present invention, as set forth in general terms above and more specifically below, it is known, in the proximity detection art, to employ a variety of location methods to detect the location of one object with respect to another. Exemplary of such prior art are U.S. Pat. No. 5,995,046 ('046) to D. K. Belcher et al., entitled “Radio Geo-Location System with Advanced First Received Wavefront Arrival Determination,” U.S. Pat. No. 6,134,448 ('448) to Y. Shoji et al., entitled “System for Detecting Positional Information,” U.S. Pat. No. 6,222,482 ('482) to A. Gueziec, entitled “Hand-Held Device Providing a Closest Feature Location in a Three-Dimensional Geometry Database,” U.S. Pat. No. 6,259,405 ('405) to B. H. Stewart et al., entitled “Geographic Based Communications Service,” U.S. Pat. No. 6,292,106 ('106) to J. C. Solinsky et al., entitled “Acoustical System and Method for Simultaneously Locating and Tracking Multiple Personnel in Rooms of a Building,” and U.S. Pat. No. 6,327,535 ('535) to S. S. Evans et al., entitled “Location Beaconing Methods and Systems.” While the '046, '448, '482, '405, '106, and '535 references disclose a variety of location methods, they are unable to determine the unique identifier, such as the network address, of the imaging device that the user is standing in front of. Therefore, a further advantageous system, then, would be presented if the location system were able to determine the unique identifier of the desired imaging device.

It is also known, in the proximity detection art, to sense the proximity of the object using near-field effects. Exemplary of such prior art is U.S. Pat. No. 5,459,405 ('405) to G. D. Wolff et al., entitled “Method and Apparatus for Sensing Proximity of an Object Using Near-Field Effects.” While the '405 reference teaches the use of near-field effects to determine the proximity of one object with respect to another, again, there is no teaching, suggesting or even appreciation for determining the unique identifier of the imaging device that the user is standing in front of. Therefore, a still further advantageous system, then, would be presented if the location system could determine the unique identifier of the imaging device that the user is standing in front of.

It is apparent from the above that there exists a need in the art for a imaging device location system which is capable of determining the unique identifier of the imaging device that the user is standing in front of, and which at least equals the location characteristics of the known location systems. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for detecting imaging device proximity, wherein the method is comprised of the steps of: using a mobile device to interact with a network list of imaging devices; changing a variable operating condition of a desired imaging device; using the mobile device to determine which imaging device on the list changed the variable operating condition; uploading, by the imaging device, of a unique identifier of imaging device to the mobile device; and printing a document on the imaging device.

In certain preferred embodiments, the mobile device can be, but is not limited to, a computer, a laptop computer, a personal digital assistant (PDA) or the like. The variable operating condition can be, but is not limited to, a change in the on-line/off-line state of the imaging device. The imaging device can be, but is not limited to, a printing device, a digital sender, a scanner or the like. The unique identifier can be, but is not limited to, a network address or the like.

In another further preferred embodiment, the imaging device physically available to the user can be found without having to decipher the sometimes cryptic definition of an imaging device presented by various operating systems.

The preferred proximity detection system, according to this invention, offers the following advantages: ease in detecting imaging device proximity; ease in determining the imaging device's unique identifier; ease of imaging; and excellent economy. In fact, in many of the preferred embodiments, these factors of ease in detecting imaging device proximity, ease in determining the imaging device's unique identifier, and ease of imaging are optimized to an extent that is considerably higher than heretofore achieved in prior, known imaging device proximity detection systems.

The above and other features of the present invention, which will become more apparent as the description proceeds, are best understood by considering the following detailed description in conjunction with accompanying drawing figures, wherein like characters represent like parts throughout the several views and in which:

### BRIEF DESCRIPTION OF THE DRAWING

FIGS. 1A and 1B are a flowchart that illustrates a method for detecting an imaging device proximity, according to one embodiment of the present invention.

### DETAILED DESCRIPTION OF INVENTION

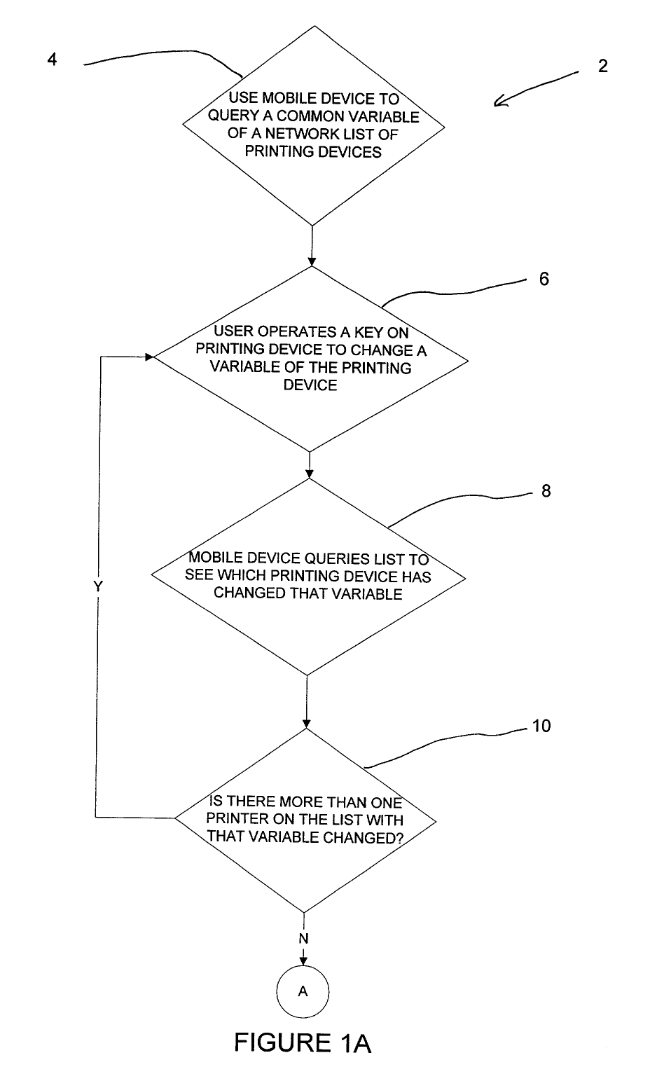

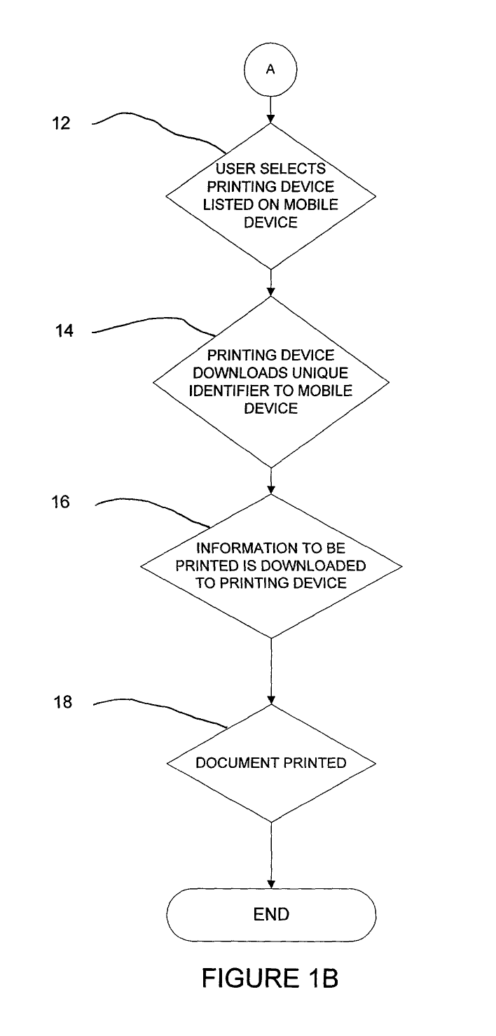

With reference to FIGS. 1A and 1B, there is illustrated one preferred embodiment for use of the concepts of this invention. Method 2 for detecting an imaging device proximity is illustrated. Method 2 includes, in part, the steps of using a mobile device to interact with/query a network list of imaging devices (step 4), having the user operate/manipulate a key or other such suitable device on a desired imaging device in order to change a variable of the desired imaging device (step 6), using the mobile device to interact with/query the network list to determine which imaging device has changed that variable (step 8), using the mobile device to determine if more than one imaging device has changed that variable (step 1), listing the location of the desired imaging device on the mobile device and having the user select to the desired imaging device listed on the mobile device (step 12), downloading of a unique identifier from the desired imaging device to the mobile device (step 14), downloading, by the mobile device, the information to be printed by the desired imaging device (step 16), and printing the information (step 18).

With respect to step 4, it is to be understood that the mobile device can be, but is not limited to, a computer, a laptop computer, a personal digital assistant (PDA) or the like. Also, the term “network list” refers to a conventionally prepared list of network addresses of all the printing devices in the area defined by the network. For example, the network list may refer to a listing of all the printers in a local area network (LAN). Finally, it is to be understood that the imaging device can be, but is not limited to, a printing device, a digital sender, a scanner or the like.

With respect to step 6, the user may, for example, activate the on/off button of the imaging device. This activation may cause the imaging device to go from the on-state to the off-state or vice versa.

With respect to step 8, a Simple Network Management Protocol (SNMP) is used during the interaction between the imaging device and the mobile device in order to determine which imaging device has experienced a change in the desired variable. SNMP is a widely used, common communications protocol that is found in almost all conventional imaging devices. SNMP allows the imaging devices or agents to provide information about themselves, such as what the imaging device can do and what can be controlled in the imaging device, in a common storage area or MIB. The information about a particular imaging device or agent can then be accessed by a user or requester, such as the user's mobile device.

With respect to step 10, if, for example, several users have activated the on/off buttons of several different imaging devices at the same time, the mobile device may show that several imaging devices are listed as having a changed on-state/off-state variable. If this is the case, the user merely has to re-activate the on/off button of the imaging device in order to again change the on-state/off-state variable of the imaging device. The mobile device will then query the network list again in order to determine which imaging devices have changed that particular variable. It is also be understood that the user can also change some other variable on the imaging device if more than one imaging devices are listed as having that variable changed.

With respect to step 12, if only one imaging device is listed on the mobile device as having the desired variable changed, the network address of that imaging device is listed on the mobile device and the user can then select that listed imaging device.

With respect to step 14, once the user is located in front of listed imaging device, the imaging device conventionally downloads a unique identifier to the user's mobile device. It is to be understood that the term “unique identifier” can be, but is not limited to, a network address, the network imaging device share name for the imaging device or any such identifier that is unique to that particular imaging device.

After the unique identifier has been downloaded to the user's mobile device, the mobile device will then be able to conventionally download the print job information on the mobile device to the imaging device, as shown in step 16. Finally, the document is printer, as shown in step 18.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for detecting an imaging device proximity, comprising the steps of:
using a mobile device to interact with a network list of imaging devices;
changing a variable operating condition of a desired imaging device;
using said mobile device to determine which imaging device on said list changed said variable operating condition;
uploading, by said imaging device, of a unique identifier of said imaging device to said mobile device; and
printing a document on said imaging device.

2. The method, as in claim 1, wherein said step of using said mobile device to interact with a network list of imaging devices is further comprised of the step of:
using said mobile device to query said variable in said network list.

3. The method, as in claim 2, wherein said variable is further comprised of:
an on-state/off-state of said desired imaging device.

4. The method, as in claim 1, wherein said step of changing said variable operating condition of said desired imaging device is further comprised of the step of:
activating an on/off button on said desired imaging device.

5. The method, as in claim 1, wherein said step of using said mobile device to determine which imaging device on the list has changed the variable operating condition is further comprised of the step of:
utilizing a common communications protocol between said imaging device and said mobile device.

6. The method, as in claim 5, wherein said common communications protocol is further comprised of:
a Simple Network Management Protocol (SNMP).

7. The method, as in claim 1, wherein said unique identifier is further comprised of:
a network address of said imaging device.

8. The method, as in claim 1, wherein said mobile device is further comprised of:
a laptop computer.

9. The method, as in claim 1, wherein said mobile device is further comprised of:
a personal digital assistant.

10. The method, as in claim 1, wherein said imaging device is further comprised of:
a printing device.

11. A program storage medium readable by a computer, tangibly embodying a program of instructions executable by said computer to perform method steps for detecting imaging device proximity, comprising of the steps of:
using a mobile device to interact with a network list of imaging devices;
changing a variable operating condition of a desired imaging device;
using said mobile device to determine which imaging device on said list changed said variable operating condition;
uploading, by said imaging device, of a unique identifier of said imaging device to said mobile device; and
printing a document on said imaging device.

12. The method, as in claim 11, wherein said step of using said mobile device to interact with a network list of imaging devices is further comprised of the step of:
using said mobile device to query said variable in said network list.

13. The method, as in claim 12, wherein said variable is further comprised of:
an on-state/off-state of said desired imaging device.

14. The method, as in claim 11, wherein said step of changing said variable operating condition of said desired imaging device is further comprised of the step of:
activating an on/off button on said desired imaging device.

15. The method, as in claim 11, wherein said step of using said mobile device to determine which imaging device on the list has changed the variable operating condition is further comprised of the step of:
utilizing a common communications protocol between said imaging device and said mobile device.

16. The method, as in claim 15, wherein said common communications protocol is further comprised of:
a simple network management protocol (SNMP).

17. The method, as in claim 11, wherein said unique identifier is further comprised of:
a network address of said imaging device.
